(19) United States
(12) Patent Application Publication
(10) Pub. No.: US 2025/0078583 A1
(43) Pub. Date: Mar. 6, 2025

(54) Cloud-Based Vehicle Diagnostic System Having Specialized Data

(71) Applicant: Robert Bosch GmbH, Stuttgart (DE)

(72) Inventor: Tyrel Alastair-Hunter, Owatonna, MN (US)

(21) Appl. No.: 18/241,123

(22) Filed: Aug. 31, 2023

(51) Int. Cl. G07C 5/08; G07C 5/00

(52) U.S. Cl. CPC G07C 5/0808; G07C 5/008

(57) ABSTRACT

Systems and methods for vehicle diagnostic services utilizing a diagnostic server. The systems comprise a diagnostic server that is in data communication with a service tool and the vehicle communication interface (VCI) of a vehicle. The data communication may be accomplished using a wide area network (WAN). The diagnostic server acquires diagnostic data from the VCI and generates a diagnostic report for a user to utilizing during service actions of the vehicle. Some embodiments utilize an external gateway adapter to enable data communication between the diagnostic server and vehicles lacking a native function to interface with external devices or components across networks.

### TECHNICAL FIELD

This disclosure relates to the servicing of a vehicle including diagnostic procedures.

### BACKGROUND

Vehicle diagnostic services are an important aspect of modern vehicle servicing. It is critical to accurately assess the operational condition of a vehicle prior to performing any service such as maintenance, calibration, or repair. An accurate assessment of the vehicle's condition can guide service personnel to an expedient and proficient performance of the necessary service tasks.

Accurate assessments of the vehicle's condition may require extensive and specialized technical knowledge. Modern vehicles may provide insights to their operational condition utilizing electronic data communication. Electronic data indicating the operational condition of the vehicle may be generated, such as diagnostic codes associated with the vehicle, a component of the vehicle, or one of the vehicle's systems. Additionally, several factors may complicate the diagnostic process and subsequent repairs. Technicians must be able to acquire vehicle operational data from the vehicle as well as vehicle ID data, as different manufacturers may utilize similar or identical operational data or diagnostic codes that have completely distinct meanings in the context of their respective vehicles. Vehicle operational data may differ from vehicle to vehicle, from component to component, and even from year to year of the same vehicle or component thereof. Additionally, the manufacturers may choose to restrict access to some data useful in completing a diagnostic service for reasons of safety, security, or intellectual property. This limited-access data may be desirable because it is for emerging technologies or for a newly released vehicle, component, or system. This diagnostic service is additionally complicated when accounting for aftermarket components and systems that may behave differently from the stock models. Thus, a comprehensive diagnostic service may require a level of technical know-how that is both broad and deep, and such a service may be expensive to acquire or maintain.

It would therefore be desirable to have a system that provides technician or other service personnel with guidance and access to a wide range of diagnostic data corresponding to a wide range of vehicle types, vehicle components, and vehicle systems that may be encountered. It may further be advantageous to provide the system in such a way that access to the desired diagnostic data may be accomplished at a reduced cost.

### SUMMARY

One aspect of this disclosure is directed to a vehicle diagnostic system comprising a diagnostic server with a memory, a vehicle communication interface (VCI) in data communication with the diagnostic server, and a human-machine interface (HMI) in data communication with the diagnostic server. The memory stores thereon instructions to interface with a plurality of diagnostic protocols. The VCI is configured to interface with a diagnostic bus of a vehicle. The HMI comprises an input component and an output component. The diagnostic server generates a vehicle diagnostic report in response to receiving diagnostic data compatible with one of the diagnostic protocols from the VCI. The diagnostic server further is configured to relay a command from the HMI to the diagnostic bus via the VCI. The diagnostic server is further configured to relay diagnostic data from the bus via the VCI to the HMI. The diagnostic server is in data communication with the HMI via a wide-area network (WAN).

Another aspect of this disclosure is directed to a method of vehicle diagnosis. The method comprises establishing a data connection between a vehicle communication interface (VCI) of a vehicle under diagnostic test and a diagnostic server via a wide-area network (WAN), establishing a data connection between a human-machine interface (HMI) and the diagnostic server via the WAN, transmitting initiation data from the HMI to the diagnostic server to initiate a diagnostic procedure of the vehicle, transmitting the initiation data from the diagnostic server to the VCI to initiate the diagnostic procedure, generating a vehicle diagnostic report based upon diagnostic data received from the VCI in response to the initiation instructions, and transmitting the vehicle diagnosis to the HMI. The VCI is data communication with a diagnostic bus of the vehicle. The diagnostic server is configured to interface with a plurality of diagnostic protocols, at least one of the plurality of diagnostic protocols being utilized by the vehicle.

A further aspect of this disclosure is directed to a vehicle diagnostic system comprising a diagnostic server with a memory, an external gateway adapter in data communication with the diagnostic server, a vehicle communication interface (VCI) in data communication with the external gateway, and a human-machine interface (HMI) in data communication with the diagnostic server. The memory stores thereon instructions to interface with a plurality of diagnostic protocols. The VCI is configured to interface with a diagnostic bus of a vehicle. The HMI has an input component and an output component. The input component is suitable for a user to input commands and data. The output component is suitable to display or otherwise deliver data or prompts to a user. The diagnostic server generates a vehicle diagnostic report in response to receiving diagnostic data compatible with one of the diagnostic protocols from the VCI. The diagnostic server is configured to relay commands from the HMI to the diagnostic bus via the gateway adapter and the VCI. The diagnostic server is configured to relay diagnostic information from the diagnostic bus via the gateway adapter and the VCI to the HMI, and the diagnostic server is in data communication with the HMI via a wide-area network (WAN).

A further aspect of this disclosure is directed to a method of vehicle diagnosis. The method comprises steps of establishing a data connection between an external gateway adapter and a diagnostic server, establishing a data connection between the external gateway adapter and a vehicle communication interface (VCI) of a vehicle under diagnostic test, establishing a data connection between a human-machine interface (HMI) and the diagnostic server via a wide area network (WAN), transmitting initiation instructions from the HMI to the diagnostic server via the external gateway adapter to initiate a diagnostic procedure of the vehicle, generating a vehicle diagnostic report based upon diagnostic data received from the VCI via the external gateway adapter in response to the initiation instructions, and transmitting the vehicle diagnosis to the HMI. The VCI is in data communication with a diagnostic bus of the vehicle under diagnostic test. The diagnostic server is configured to interface with a plurality of diagnostic protocols, at least one of which being utilized by the vehicle under diagnostic test.

The above aspects of this disclosure and other aspects will be explained in greater detail below with reference to the attached drawings.

### BRIEF DESCRIPTION OF THE DRAWINGS

FIG. 1 is a diagrammatic illustration of a vehicle diagnostic system according to one embodiment of the teachings herein.

FIG. 2 is a diagrammatic illustration of a vehicle diagnostic system according to a second embodiment of the teachings herein.

FIG. 3 is a diagrammatic illustration of a vehicle diagnostic system according to a third embodiment of the teachings herein.

FIG. 4 is a diagrammatic illustration of a vehicle diagnostic system according to a fourth embodiment of the teachings herein.

FIG. 5 is a flowchart illustrating a method of vehicle diagnosis according to an embodiment of the teachings herein.

FIG. 6 is a flowchart illustrating a method of vehicle diagnosis according to a second embodiment of the teachings herein.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

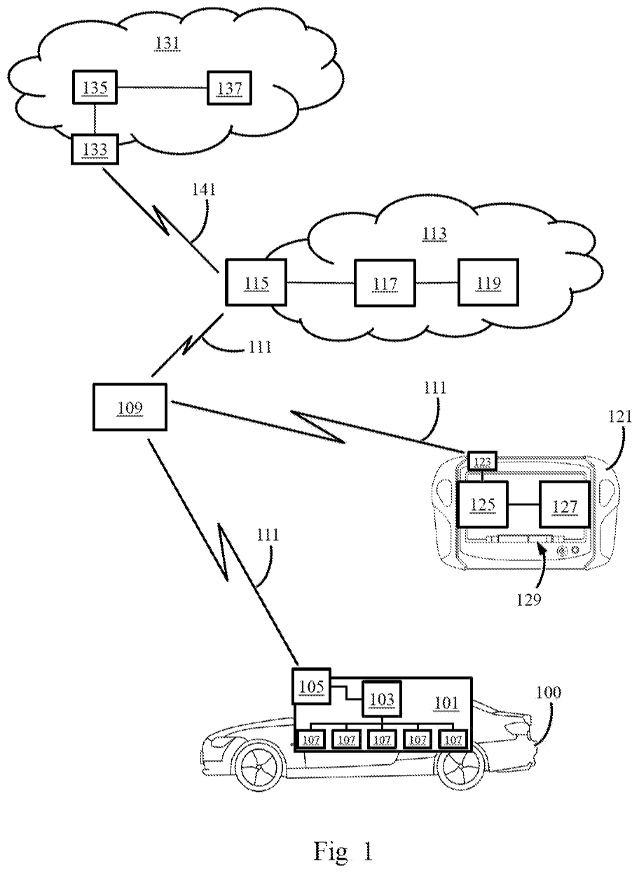

FIG. 1 depicts a vehicle 100 under diagnostic test using a diagnostic system according to one embodiment of the teachings disclosed herein. In the depicted embodiment, vehicle 100 comprises a diagnostic bus 101 that provides data communication between multiple components of the vehicle. In this embodiment, vehicle 100 comprises a vehicle processor 103, vehicle communication interface (VCI) 105, and a number of electronic control units (ECUs) 107. In this depiction, vehicle 100 comprises five ECUs 107, but other embodiments may comprise a different number of ECUs 107 without deviating from the teachings disclosed herein. In the depicted embodiment, vehicle processor 103 is a distinct processing component from VCI 105 and all of ECUs 107. In some embodiments, one or more of VCI 105 and ECUs 107 comprise self-contained processors or sub-processors, and in such embodiments, these elements may provide the functionality of vehicle processor 103 without deviating from the teachings disclosed herein. In such embodiments, vehicle 100 may not comprise a vehicle processor 103 without deviating from the teachings disclosed herein.

Other embodiments may comprise additional or different components of vehicle 100 in data communication with diagnostic bus 101 without deviating from the teachings disclosed herein. In the depicted embodiment, vehicle 100 comprises a consumer sedan, but other embodiments may comprise other configurations without deviating from the teachings herein. In some such embodiments, vehicle 100 may instead comprise a compact car, minivan, truck, light truck, sport utility vehicle, station wagon, crossover vehicle, motorcycle, motorized tricycle, side-by-side vehicle, all-terrain vehicle, recreational motor vehicle, industrial transport, commercial automobile, watercraft, or aircraft without deviating from the teachings disclosed herein.

In the depicted embodiment, diagnostic bus 101 comprises a controlled area network (CAN) bus protocol, but other embodiments may comprise different diagnostic protocols without deviating from the teachings disclosed herein. Diagnostic bus 101 may additionally utilize a plurality of diagnostic protocols to enable data communication between components of vehicle 100 without deviating from the teachings disclosed herein. Such embodiments may utilize a protocol such as CAN, single wire CAN, Controller Area Network Fault Tolerant (CAN FT), Controller Area Network Extra Long (CAN XL), Controller Area Network Flexible Data-Rate (CAN FD), Local Interconnect Network (LIN), Universal Asynchronous Receiver/Transmitter Based Protocol (UART/UBP), Keyword 2000 (KWP2000), ISO 9141, ISO 15765, ISO 14230, ISO 11783, J1587, J1850PWM, J1850VPW, J1708, J1939, Diagnostics Over Internet Protocol (DOIP), Domestic Digital Bus (D2B), Scalable Coherent Interface (SCI), Serial Peripheral Interface (SPI), FlexRay, Byteflight, Multifunction Vehicle Bus, Vehicle Area Network (VAN), Uncomplicated Application-level Vehicular Communication And Network (UAVCAN), or any other known standard of data communication between electronic components without deviating from the teachings disclosed herein.

Vehicle processor 103 is configured to perform computations, execute instructions, and organize transmissions between components of vehicle 100. Vehicle processor 103 may be in additional data communication with a vehicle memory (not shown) providing executable instructions to the processor. The data communication between vehicle processor 103 and the vehicle memory may be accomplished with a direct interface of the two components or by utilizing diagnostic bus 101 without deviating from the teachings disclosed herein.

VCI 105 provides data communication between components of vehicle 100 associated with diagnostic bus 101 and other devices or systems external to the vehicle. In the depicted embodiment, VCI 105 comprises a gateway module 105 in data communication with vehicle processor 103. In the depicted embodiment, gateway module 105 comprises a combination of hardware and software components, but other embodiments can comprise embodiments using hardware, firmware, or software implementations, or any combination thereof without deviating from the teachings disclosed herein. In practice, gateway module 105 behaves as a transmitter and receiver providing communication functions between vehicle 100 and external devices, components, or systems. In the depicted embodiment, gateway module 105 is in data communication with a wide area network (WAN) 109 via a data communication connection 111. Gateway module 105 may comprise one or more data communication protocols suitable to establish a data communication connection. In the depicted embodiment, WAN 109 comprises the Internet and gateway module 105 comprises an encrypted wireless data transceiver, but other embodiments may comprise other configurations without deviating from the teachings disclosed herein. Gateway module 105 may be configured to communicate with one or more modes of operation. In some embodiments, data communication connection 111 may comprise a wireless connection comprising via one or more of an RF (radio frequency) specification, cellular phone channels (analog or digital), cellular data channels, a Subscriber Identity Module (SIM) connection, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art. In some embodiments, data communication connection 111 may comprise a TCP/IP connection, a plain-old-telephone-service (POTS) connection, an Internet protocol connection, an electrical wiring, a conductive channel, an electrical bus, a fiber optic pathway, or any other alternative embodiment known to one of ordinary skill in the art. In some embodiments, the connection between gateway module 105 and WAN 109 may be accomplished via a local area network (LAN; not shown) without deviating from the teachings disclosed herein.

Vehicle 100 is further configured to provide diagnostic data in response to a request received by the gateway module 105. In the depicted embodiment, diagnostic data is generated by vehicle processor 103 in response to receiving the request. Vehicle processor 103 acquires diagnostic data indicating the status of one or more of the other components of vehicle 100 (e.g., ECUs 107) and provides the diagnostic data to gateway module 105 for transmission to the requester. In the depicted embodiment, a request may be generated by a diagnostic server 113 in data communication with vehicle 100 via WAN 109. Diagnostic server 113 comprises a server transceiver 115 configured to transmit and receive data communications from other systems, devices, or components external to diagnostic server 113. Diagnostic server further comprises a server processor 117 and a server memory 119. Server processor 117 is configured to execute instructions provided to it, and server memory stores thereon instructions for functions of server processor 117. In the depicted embodiment, server memory 119 further comprises a database of information suitable to interpret diagnostic data received from a vehicle, such as vehicle 100. In the depicted embodiment, server transceiver 115 is implemented as a single component, but other embodiments may comprise separate transmitters and receivers without deviating from the teachings disclosed herein.

Diagnostic server 113 is configured to acquire diagnostic data from vehicle 100 indicating the status of one or more components of vehicle 100. Because vehicle 100 may utilize one or more of a plurality of diagnostic protocols, server memory 119 stores thereon information suitable to interpret the data of all supported diagnostic protocols expected to be encountered. For this reason, server memory 119 in the depicted embodiment stores thereon information useful for interpreting diagnostic data received from a range of makes and models of vehicles using a variety of protocols. Such protocols may include, but are not limited to, CAN, single wire CAN, Controller Area Network Fault Tolerant (CAN FT), Controller Area Network Extra Long (CAN XL), Controller Area Network Flexible Data-Rate (CAN FD), Local Interconnect Network (LIN), Universal Asynchronous Receiver/Transmitter Based Protocol (UART/UBP), Keyword 2000 (KWP2000), ISO 9141, ISO 15765, ISO 14230, ISO 11783. J1587. J1850PWM. J1850VPW, J1708. J1939, Diagnostics Over Internet Protocol (DOIP), Domestic Digital Bus (D2B). Scalable Coherent Interface (SCI), Serial Peripheral Interface (SPI), FlexRay, Byteflight, Multifunction Vehicle Bus, Vehicle Area Network (VAN), Uncomplicated Application-level Vehicular Communication And Network (UAVCAN), or any other known standard of data communication between electronic components without deviating from the teachings disclosed herein.

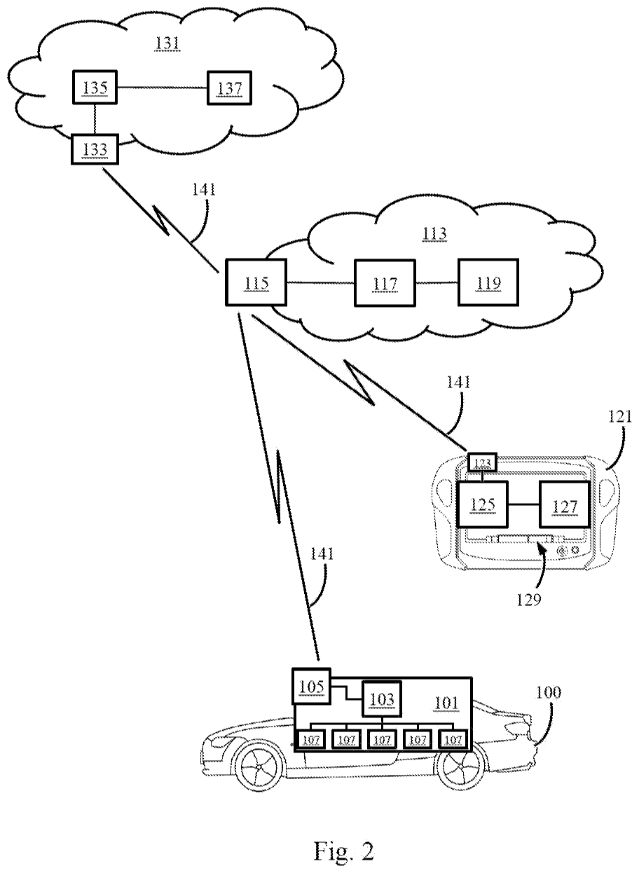

In the depicted embodiment, diagnostic server 113 is in data communication with vehicle 100 indirectly via a data communication connection 111 with WAN 109, but other embodiments may comprise other configurations (see, e.g., FIG. 2). Diagnostic server 113 is configured to utilize diagnostic data from a vehicle (such as vehicle 100) to generate a diagnostic report suitable for a user to inspect and utilize during service of the vehicle. This diagnostic report can be presented to a user via a service tool 121. In the depicted embodiment, service tool 121 is in indirect data communication with diagnostic server 113 via WAN 109 via tool transceiver 123. In the depicted embodiment, tool transceiver 123 establishes a data communication connection 111 with WAN 109 that is utilized to establish data communication with diagnostic server 113. Service tool 121 comprises a tool processor 125 in data communication with the tool transceiver 123 and a tool memory 127. Tool memory 127 comprises instructions stored thereon that are executable by tool processor 125. In some embodiment, tool memory 127 may comprise additional information suitable to interpret some diagnostic data from a selection of makes and models of vehicles without deviating from the teachings disclosed herein.

Service tool 121 additionally comprises a human-machine interface (HMI) 129 having an input component and an output component. In the depicted embodiment, the HMI 129 comprises a touchscreen display and a plurality of hardware buttons and soft buttons to provide a user the ability to observe data and input instructions, but other embodiments may comprise other configurations without deviating from the teachings disclosed herein. Other such embodiments may comprise additional or other input components, such as a voice input, microphone, haptic input, gesture input, keyboard, mouse, specialized button or button array, or any other input component or combination of input components recognized by one of ordinary skill without deviating from the teachings disclosed herein. Other such embodiments may comprise additional or other output components, such as an auditory output, illuminated indicators, visual display, external monitor, haptic output, printer, augmented reality display, or any other output device or combination of output devices recognized by one of ordinary skill in the art without deviating from the teachings disclosed herein.

In the depicted embodiment, service tool 121 comprises a mobile computing device in the form of a specialized diagnostic tablet computer, but other embodiments may comprise other configurations without deviating from the teachings disclosed herein. In such embodiments, service tool 121 may be embodied as a mobile processing device, a smartphone, a conventional tablet computer, a laptop computer, a wearable computing device, a desktop computer, a personal digital assistant (PDA) device, a spatial computing device, an augmented reality computing device, a mixed reality computing device, an alternative reality computing device, a handheld processor device, a specialized processor device, a system of processors distributed across a network, a system of processors configured in wired or wireless communication, or any other alternative embodiment known to one of ordinary skill in the art.

Although in the depicted embodiment the system comprises a single service tool 121, other embodiments may comprise a plurality of service tools 121 in the system without deviating from the teachings disclosed herein. A plurality of service tools 121 may be utilized with respect to a single vehicle 100, or with respect to a plurality of vehicles. In such embodiments, a team of technicians can more efficiently perform service actions upon a plurality of vehicles than a single technician operating a single service tool 121. In some such embodiments comprising a plurality of service tools 121, each of the service tools 121 may be in data communication with each other to organize and prioritize interactions between service tools 121, the diagnostic server 113, and the vehicle 100 via WLAN 109.

In the depicted embodiment, some features of the diagnostic server 113 may be controlled by legal requirement or license agreement. By way of example, and not limitation, some of the diagnostic operations of server 113 may require additional confirmation by a proprietary tool or specialized diagnostic processor provided by an original manufacturer to maintain the warranty or certify completed service for particular makes and models of a vehicle. In such instances, diagnostic server 113 may additionally provide access to a specialty server 131 which provides such specialized functions remotely from diagnostic server 113. In the depicted embodiment, specialized server 131 is in data communication with diagnostic server 115 via a proprietary connection 141 between server transceiver 115 and a specialized transceiver 133 of specialized server 131. In the depicted embodiment, proprietary connection 141 comprises a direct connection with encryption for data security, but other embodiments may utilize other connections, such as a connection similar to data connection 111 without deviating from the teachings disclosed herein. In some embodiments, the data communication between specialty server 131 and diagnostic server 113 may be achieved using an indirect connection, such as utilizing WLAN 109 or a different network connection without deviating from the teachings disclosed herein.

Specialty server 131 further comprises a specialty processor 135 and a specialty memory 137 having instructions stored thereon suitable to be executed by the specialty processor 135. Included amongst the instructions stored upon specialty memory 137 is instructions to perform at least one specialty diagnostic operation not available using the information available in server memory 119. Specialty memory 137 may additionally comprise additional information not otherwise available in server memory 119, such as updated or latest-model diagnostic information tables. These instructions and information are then used upon request from the diagnostic server 113 to generate information suitable for a diagnostic report regarding makes or models of vehicles or components of vehicles in circumstances requiring access to the specialized server 131. In the depicted embodiment, the system comprises a single specialized server 131, but other embodiments may comprise a plurality of specialized servers 131 without deviating from the teachings disclosed herein. In such embodiments, each of the plurality of specialized servers 131 may correspond to a different manufacturer of vehicles and/or components, providing a unique set of specialized information to the diagnostic services performed by diagnostic server 131.

Access to the specialty server 131 may require authorization, which may take the form of user certification or monetary transaction. In one such embodiment, a user requesting specialized information or diagnostic services from specialty server 131 may be required to input an authorization code via the HMI 129. The authorization code may take the form of an identification number, a certificate number, a registration number, a password, a passcode, or a biometric input such as a fingerprint, face scan, eye scan, voiceprint, or any other authorization mechanism recognized by one of ordinary skill in the art without deviating from the teachings disclosed herein. In such embodiments requiring a biometric input, HMI 129 will comprise the necessary components required to enable the input, such as a fingerprint scanner, eye scanner, camera sensor, microphone, or the like. In embodiments where access to specialty server 131 is authorized based upon monetary transaction, a user may be offered access to specialty server 131 via a request presented to the user via HMI 129. Access to the specialty server may be authorized on a subscription basis, an ad hoc basis, or some combination thereof. By way of example, and not limitation, some functions of specialty server 131 may be offered only to users having a subscription, and other functions may only be available for users who charge on an ad hoc per-use basis. In some embodiments, specialty server 131 may have different tiers of authorization requiring different levels of authorization. Each of these tiers may require a different user certification, monetary transaction, or some combination thereof. By way of example, and not limitation, a first function may require a basic level of subscription at a first monthly fee, whereas a second function may require an enhanced level of subscription at a second higher monthly fee. In such embodiments, one or more functions requiring the enhanced level of subscription may be made available at an ad hoc basis to users who do not meet the subscription requirements without deviating from the teachings disclosed herein. In embodiments utilizing multiple specialty servers 131, each of the specialty servers 131 may require different authorization requirements or combinations thereof from each other without deviating from the teachings disclosed herein. By way of example, and not limitation, different servers that offer different functions because they are dedicated to different manufacturers of vehicles may arrange for different access requirements according to licensing agreements or sales plans preferred by the associated manufacturer without deviating from the teachings disclosed herein.

FIG. 2 illustrates an alternative embodiment of the system of vehicle diagnosis that does not rely upon WAN 109 (see FIG. 1). In this embodiment, each of vehicle 100, service tool 121, and specialty server 131 is in data communication via a direct data connection 141 with diagnostic server 113. In this alternative embodiment, all of the functions of the vehicle 100, diagnostic server 113, service tool 121, and specialty server 131 behave identically to the previous embodiment, but the data communication between each of them utilizes a direct connection rather than relying upon a wide area network. In this embodiment, direct data connections 141 may comprise a local area network connection, short-range radio connection, WiFi connection, Blue Tooth connection, Zigbee wireless connection, or any other direct data communication protocol recognized by one of ordinary skill in the art for direct and/or local data communication without deviating from the teachings disclosed above. In the depicted embodiment, one or more of the direct data connections 141 may be encrypted to improve security of the data transmission without deviating from the teachings disclosed herein.

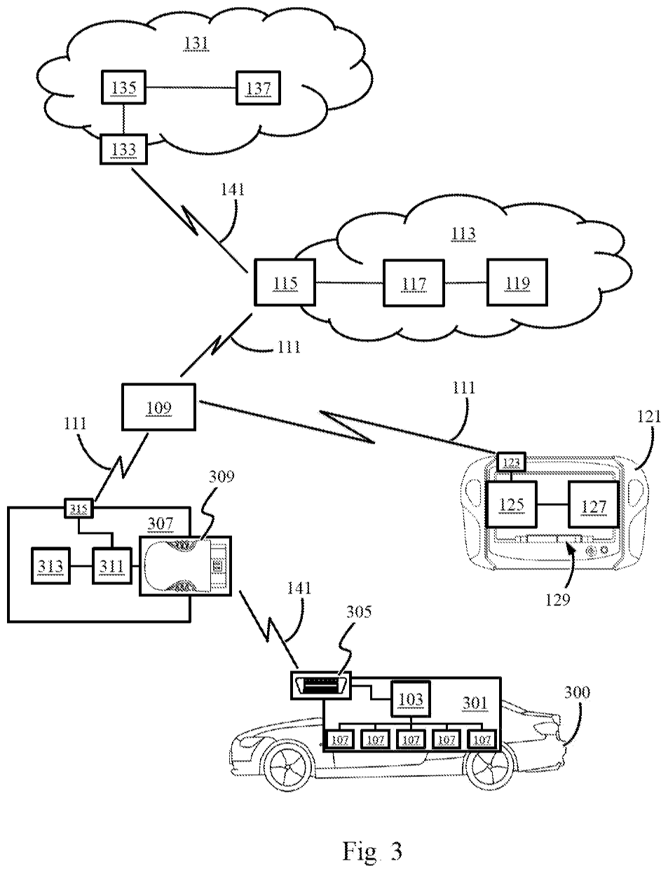

A vehicle may remain in service for long periods of time, and as such older vehicles may not have a native gateway module, such as gateway module 105 installed at the time of manufacture. However, it remains desirable to maintain accessibility to these older vehicles using the diagnostic systems. FIG. 3 is an illustration of an alternative embodiment of the vehicle diagnostic system that is provided to service a vehicle 300 that comprises a different configuration. Vehicle 300 is very similar to vehicle 100 (see FIG. 1) except that its diagnostic bus 301 does not comprise a native gateway module. Instead, vehicle 300 provides access to its diagnostic bus 301 by way of a bus access port 305. Other components of vehicle 300 depicted are otherwise identical to components of vehicle 100 (see FIG. 1), but other embodiments may comprise alternative configurations without deviating from the teachings disclosed herein. As with respect to the vehicle 100 of FIG. 1, vehicle 300 is depicted as a consumer sedan, but other embodiments may comprise other configurations without deviating from the teachings herein. In some such embodiments, vehicle 300 may instead comprise a compact car, minivan, truck, light truck, sport utility vehicle, station wagon, crossover vehicle, motorcycle, motorized tricycle, side-by-side vehicle, all-terrain vehicle, recreational motor vehicle, industrial transport, watercraft, or aircraft without deviating from the teachings disclosed herein.

In the depicted embodiment, bus access port 305 comprises an onboard diagnostic port conforming to an onboard diagnostic bus protocol, such as a J1962 port supporting an OBD-II protocol. However, other embodiments may comprise other configurations utilizing different port or protocol specifications without deviating from the teachings disclosed herein. Access to the diagnostic bus 301 is achieved via an external gateway adapter 307, which comprises a port connector 309, an adapter processor 311, an adapter memory 313, and an adapter transceiver 315. Adapter processor is in data communication with each of adapter connector 309, adapter memory 313, and adapter transceiver 315. Adapter memory has instructions stored thereon to be executed by adapter processor 313. The instructions stored thereon are directed to providing external gateway adapter 307 the same functionality as gateway module 105 (see FIG. 1) would provide in vehicle 100. In particular, external gateway adapter 307 provides a conduit for communication between diagnostic bus 301 and diagnostic server 113. In the depicted embodiment, this data communication is achieved via WAN 109 and a number of data communication connections 111. This interface permits diagnostic server 113 to request diagnostic data from vehicle 300 and receive the diagnostic data in response in order to generate the diagnostic report for presentation to the user via service tool 121. As disclosed above with respect to FIG. 1, a user may control the diagnostic processes via the HMI 129 of service tool 121.

In the depicted embodiment, adapter transceiver 315 comprises a single transceiver component suitable for transmission and reception of data from compatible data connections, but other embodiments may be implemented having a distinct transmitter component and receiver component without deviating from the teachings disclosed herein.

In the depicted embodiment, external gateway adapter 307 comprises a proprietary hardware device, but other embodiments may comprise alternative configurations without deviating from the teachings disclosed herein. In such embodiments, external gateway adapter 307 may comprise a generalized computing device, a mobile processing device, a smartphone, a conventional tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art. In such embodiments, an additional component may be utilized to provide the functionality of port connector 309 to the external gateway adapter 307. In such embodiments, the port connector 309 may comprise a universal serial bus (USB) connector, IEEE 1394 (Firewire) connector, an Ethernet connector, a Thunderbolt connector, a Peripheral Component Interconnect (PCI) connector, a Serial AT Attachment (SATA) connector, Parallel AT Attachment (PATA) connector, or any other conventional data interface connector known to one of ordinary skill in the art to bridge the data communication between bus access port 305 and an alternative configuration for external gateway adapter 307 without deviating from the teachings disclosed herein.

In some embodiments, external gateway adapter 307 may be an integrated or external component in direct data connection with the service tool 121 without deviating from the teachings disclosed herein. In such embodiments, service tool 121 may comprise an on-board connector or port that is natively compatible with bus access port 305. In some such embodiments, the functions of adapter processor 311, adapter memory 313, and adapter transceiver 315 may instead by performed by tool processor 125, tool memory 127, and tool transceiver 123 respectively without deviating from the teachings disclosed herein.

In some embodiments, port connector 309 may be implemented as a dongle component distinct from the other elements of external gateway adapter 307 without deviating from the teachings disclosed herein. In such embodiments, port connector 309 may be in data communication with adapter processor via a wireless data connection without deviating from the teachings disclosed herein. Such an embodiment may advantageously permit a user to connect port connector 309 more easily in spaces where bus access port 305 is small, confined, or otherwise difficult to access by larger hardware elements.

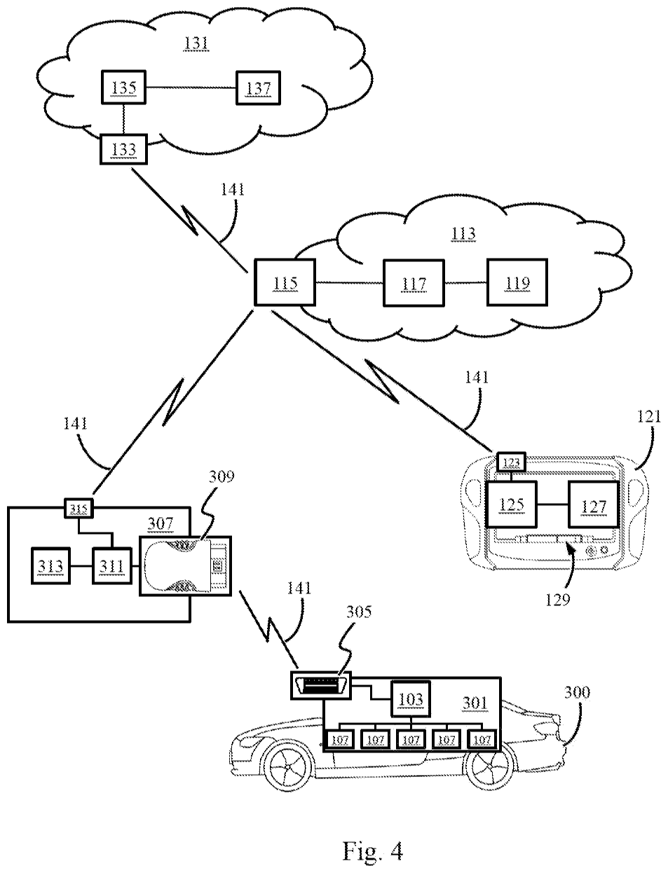

FIG. 3 depicts an arrangement of the invention disclosed herein that is analogous to the embodiment of FIG. 1, which relies upon WAN 109 to enable data communication between diagnostic server 113 and the other components of the system. FIG. 4 depicts an alternative embodiment, analogous to FIG. 2, wherein the diagnostic server 113 is in direct data communication with the other components utilizing direct data connections 141. All of the components of the embodiment of FIG. 4 are functionally identical as described above with respect to FIG. 3, except that the connections utilized are direct data connections 141. One or more of the direct data connections 141 may be encrypted for additional security in the transmission of data without deviating from the teachings disclosed herein.

Some additional embodiments of the system may utilize a different combination of data connections between the components. By way of example, and not limitation, external gateway adapter 307 may utilize a direct data connection 141 with diagnostic server 113 while service tool 121 utilizes a data communication connection 111 routed indirectly via WAN 109 without deviating from the teachings disclosed herein.

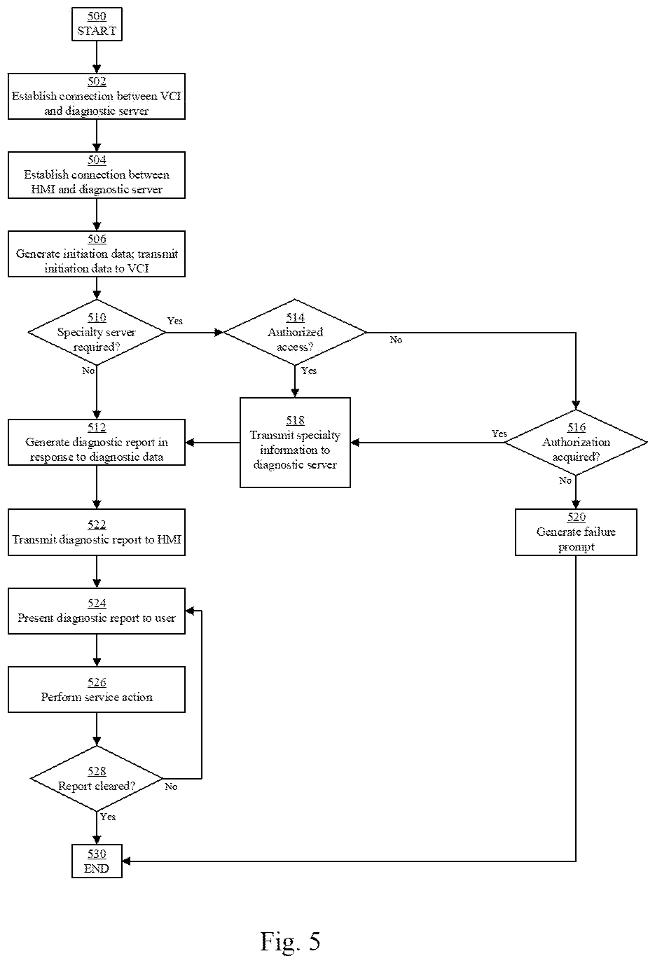

FIG. 5 is a flowchart illustrating a method of vehicle diagnostic service according to one embodiment of the teachings herein. The method begins at step 500 and proceeds to establish a data communication connection between a vehicle communication interface (VCI) of a vehicle under service and a diagnostic server at step 502. The VCI provides an interface for external devices to communication with a diagnostic bus of the vehicle. In the depicted embodiment, the VCI comprises a gateway module installed in the vehicle by the manufacturer, but other embodiments may comprise other configurations without deviating from the teachings disclosed herein. In the depicted embodiment, the diagnostic bus may comprise a controller area network (CAN) protocol, but other embodiments may comprise other configurations without deviating from the teachings disclosed herein. The diagnostic server may be compatible with CAN protocols and one or more other diagnostic protocols, to optimize compatibility of the system with a wide range of vehicles and components. By way of example, and not limitation, the diagnostic server may be compatible with a plurality of protocols. Such protocols may include, but are not limited to, CAN, single wire CAN, Controller Area Network Fault Tolerant (CAN FT), Controller Area Network Extra Long (CAN XL), Controller Area Network Flexible Data-Rate (CAN FD), Local Interconnect Network (LIN), Universal Asynchronous Receiver/Transmitter Based Protocol (UART/UBP), Keyword 2000 (KWP2000), ISO 9141, ISO 15765, ISO 14230, ISO 11783, J1587. J1850PWM, J1850VPW, J1708, J1939, Diagnostics Over Internet Protocol (DOIP), Domestic Digital Bus (D2B), Scalable Coherent Interface (SCI). Serial Peripheral Interface (SPI), FlexRay, Byteflight, Multifunction Vehicle Bus, Vehicle Area Network (VAN), Uncomplicated Application-level Vehicular Communication And Network (UAVCAN), or any other known standard of data communication between electronic components without deviating from the teachings disclosed herein.

Next, at step 504 data communication connection is established between the diagnostic server and a human-machine interface (HMI) in use by a user. Once this connection has been established, the diagnostic server can be utilized to pass information between the HMI and the VCI in addition to performing functions directed to each of the VCI and the HMI distinctly. In the depicted embodiment, the connection between the diagnostic server and the HMI is established after the connection between the diagnostic service and the VCI, but other embodiments may reverse the order of steps 502 and 504, or perform the steps contemporaneously, without deviating from the teachings disclosed herein. The method then proceeds to step 506 where the initiation data is generated. Initiation data can comprise a command from the HMI or a control signal generated by the diagnostic server. In some embodiments, the initiation data can be autonomously generated in response to the establishing of data communication between the diagnostic server and the VCI without deviating from the teachings disclosed herein. In the depicted embodiment, the data communication connection between the diagnostic server and the HMI comprises a wide area network (WAN), such as the Internet, but other embodiments may comprise other limitations without deviating from the teachings disclosed herein.

The initiation data is transmitted to the VCI as a request to generate and transmit diagnostic data from the associated vehicle to the diagnostic server. At step 510, the diagnostic data is analyzed by the diagnostic server to determine if any access to a specialty server is required to properly address interpret the diagnostic data. A specialty server may be required if the vehicle under service, or a particular component of the vehicle utilizes a specialty diagnostic protocol or comprises specialty information not made available to the general-purpose diagnostic server information. In some embodiments, such specialty information may be required by a manufacturer to protect their proprietary intellectual property, to ensure that only a user with a specified level of certification can authorize the information, to comply with a license agreement of the manufacturer, or to comply with warranty requirements for the vehicle or component.

Step 510 may be completed multiple times in parallel if the diagnostic data indicates that multiple specialty servers are required for a complete diagnosis of the vehicle. If no access to a specialty server is required, the method continues to step 512 and the diagnostic server generates a diagnostic report for presentation to a user via the HMI. If a specialty server is required, the method instead advances to step 514, where the specialty server checks if a user is authorized to access the information thereon. If the user is not authorized to access the information, the method moves to step 516 where an authorization process is initiated. The authorization process reflects the authorization requirements of the particular specialty server in use which harbors the desired information. Authorization may comprise user identification, proof of certification, or monetary transaction. User identification may be accomplished by a password test, biometric scan, certification response, or other identification known to one of ordinary skill in the art without deviating from the teachings disclosed herein. Monetary transaction may comprise a subscriber model, or an ad hoc or pay-per-use model. Authorization is performed by a user via the HMI, and the responses to the authorization process are transmitted to the specialty server by way of the diagnostic server's data communication with the HMI.

If the authorization process is successful in step 516, or if the user was otherwise authorized to access the specialty server in step 514, the method proceeds to step 518, and the specialty server transmits the desired information to the diagnostic server for use. If the user fails to successfully acquire authorization, the method instead proceeds to step 520 where a failure prompt is generated and presented to the user via the HMI. In the depicted embodiment, the method ends after step 520, but other embodiments may instead proceed to step 512 where the diagnostic report is generated as completely as possible using only the information available to the user via the diagnostic server and any successfully authorized specialty servers in use.

In some embodiments, the vehicle diagnosis system may not comprise any specialty servers without deviating from the teachings disclosed herein. In such embodiments, the methods may omit steps 510 and steps 514-520 without deviating from the teachings disclosed herein.

After a diagnostic report has been generated by the diagnostic server, the diagnostic server transmits the diagnostic report to the HMI at step 522. Once a user has a complete diagnostic report, the contents of the report are presented to the user at step 524. In the depicted embodiment, the diagnostic report may be presented utilizing a visual display, but other embodiments may provide other configurations without deviating from the teachings disclosed herein. Other embodiments may utilize audio outputs, haptic outputs, some combination of visual, audio, and haptic outputs without deviating from the teachings disclosed herein.

Once the diagnostic report is presented to a user at step 524, the diagnostic report may be utilized by a user to perform service actions for the vehicle. The user can respond to a particular element of the diagnostic report at step 526 with an appropriate service action. Once the service action is completed, the diagnostic report is updated with an indication that the service action was performed, and the method proceeds to step 528. At step 528, it is determined if there are any other elements of the diagnostic report that have not yet been addressed. If additional elements of the diagnostic report have not been addressed, the method returns to step 524 to permit a user to address another element of the diagnostic report. If all elements of the diagnostic report have been addressed, the method proceeds to step 530 and the method ends.

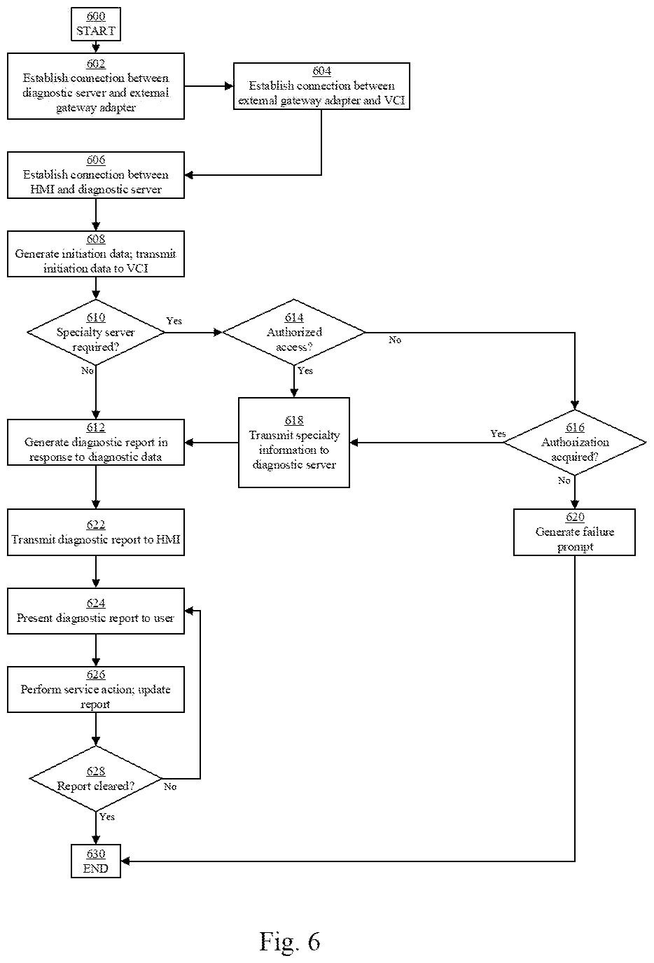

FIG. 6 is a flowchart illustrating a method of vehicle diagnostic service according to a second embodiment of the teachings herein. The method begins at step 600 and proceeds to establish a data communication connection between an external gateway adapter and a diagnostic server at step 602. The external gateway adapter is suitable to interface with a vehicle communication interface (VCI) of a vehicle having a diagnostic bus. A data communication connection is further established between the external gateway adapter and the VCI at the next step 604. This series of connections provides an indirect data communication connection between the diagnostic server and the diagnostic bus of the vehicle via the external gateway adapter and the VCI.

In the depicted embodiment, the connection between the diagnostic server and the external gateway adapter is established before establishing the connection between the external gateway adapter and the VCI, but other embodiments may reverse steps 602 and 604, or perform them contemporaneously, without deviating from the teachings disclosed herein.

The VCI provides an interface for external devices to communication with a diagnostic bus of the vehicle. In the depicted embodiment, the VCI comprises an onboard diagnostic port, such as a J1962 port, which is supported by a connector of the external gateway adapter. In this embodiment, the external gateway adapter provides an aftermarket solution to interface the vehicle with the diagnostic service that advantageously does not require modification of the vehicle. Other embodiments may comprise other configurations without deviating from the teachings disclosed herein.

In the depicted embodiment, the diagnostic bus may comprise a controller area network (CAN) protocol, but other embodiments may comprise other configurations without deviating from the teachings disclosed herein. The diagnostic server may be compatible with CAN protocols and one or more other diagnostic protocols to optimize compatibility of the system with a wide range of vehicles and components. By way of example, and not limitation, the diagnostic server may be compatible with a plurality of protocols. Such protocols may include, but are not limited to, CAN, single wire CAN, Controller Area Network Fault Tolerant (CAN FT), Controller Area Network Extra Long (CAN XL), Controller Area Network Flexible Data-Rate (CAN FD), Local Interconnect Network (LIN), Universal Asynchronous Receiver/Transmitter Based Protocol (UART/UBP), Keyword 2000 (KWP2000), ISO 9141, ISO 15765. ISO 14230, ISO 11783, J1587, J1850PWM, J1850VPW, J1708, J1939, Diagnostics Over Internet Protocol (DOIP), Domestic Digital Bus (D2B), Scalable Coherent Interface (SCI), Serial Peripheral Interface (SPI), FlexRay, Byteflight, Multifunction Vehicle Bus, Vehicle Area Network (VAN), Uncomplicated Application-level Vehicular Communication And Network (UAVCAN), or any other known standard of data communication between electronic components without deviating from the teachings disclosed herein.

Next, at step 606 data communication connection is established between the diagnostic server and a human-machine interface (HMI) in use by a user. Once this connection has been established, the diagnostic server and external gateway adapter can be utilized in tandem to pass information between the HMI and the VCI. The diagnostic server may additionally perform functions directed to each of the VCI and the HMI distinctly. In the depicted embodiment, the connection between the diagnostic server and the HMI is established after the other data connections, but other embodiments may arrange steps 602, 604, and 606 in any order, or perform two or more of the steps contemporaneously, without deviating from the teachings disclosed herein. The method then proceeds to step 608 where the initiation data is generated. Initiation data can comprise a command from the HMI or a control signal generated by the diagnostic server. In some embodiments, the initiation data can be autonomously generated in response to the establishing of data communication between the diagnostic server and the VCI without deviating from the teachings disclosed herein. In the depicted embodiment, the data communication connection between the diagnostic server and the HMI comprises a wide area network (WAN), such as the Internet, but other embodiments may comprise other limitations without deviating from the teachings disclosed herein.

The initiation data is transmitted to the VCI as a request to generate and transmit diagnostic data from the associated vehicle to the diagnostic server. At step 610, the diagnostic data is analyzed by the diagnostic server to determine if any access to a specialty server is required to properly address interpret the diagnostic data. A specialty server may be required if the vehicle under service, or a particular component of the vehicle utilizes a specialty diagnostic protocol or comprises specialty information not made available to the general-purpose diagnostic server information. In some embodiments, such specialty information may be required by a manufacturer to protect their proprietary intellectual property, to ensure that only a user with a specified level of certification can authorize the information, to comply with a license agreement of the manufacturer, or to comply with warranty requirements for the vehicle or component.

Step 610 may be completed multiple times in parallel if the diagnostic data indicates that multiple specialty servers are required for a complete diagnosis of the vehicle. If no access to a specialty server is required, the method continues to step 612, and the diagnostic server generates a diagnostic report for presentation to a user via the HMI. If a specialty server is required, the method instead advances to step 614, where the specialty server checks if a user is authorized to access the information thereon. If the user is not authorized to access the information, the method moves to step 616 where an authorization process is initiated. The authorization process reflects the authorization requirements of the particular specialty server in use which harbors the desired information. Authorization may comprise user identification, proof of certification, or monetary transaction. User identification may be accomplished by a password test, biometric scan, certification response, or other identification known to one of ordinary skill in the art without deviating from the teachings disclosed herein. Monetary transaction may comprise a subscriber model, or an ad hoc or pay-per-use model. Authorization is performed by a user via the HMI, and the responses to the authorization process are transmitted to the specialty server by way of the diagnostic server's data communication with the HMI.

If the authorization process is successful in step 616, or if the user was otherwise authorized to access the specialty server in step 614, the method proceeds to step 618, and the specialty server transmits the desired information to the diagnostic server for use. If the user fails to successfully acquire authorization, the method instead proceeds to step 620 where a failure prompt is generated and presented to the user via the HMI. In the depicted embodiment, the method ends after step 620, but other embodiments may instead proceed to step 612 where the diagnostic report is generated as completely as possible using only the information available to the user via the diagnostic server and any successfully authorized specialty servers in use.

In some embodiments, the vehicle diagnosis system may not comprise any specialty servers without deviating from the teachings disclosed herein. In such embodiments, the methods may omit steps 610 and steps 614-620 without deviating from the teachings disclosed herein.

After a diagnostic report has been generated by the diagnostic server, the diagnostic server transmits the diagnostic report to the HMI at step 622. Once a user has a complete diagnostic report, the contents of the report are presented to the user at step 624. In the depicted embodiment, the diagnostic report may be presented utilizing a visual display, but other embodiments may provide other configurations without deviating from the teachings disclosed herein. Other embodiments may utilize audio outputs, haptic outputs, some combination of visual, audio, and haptic outputs without deviating from the teachings disclosed herein.

Once the diagnostic report is presented to a user at step 624, the diagnostic report may be utilized by a user to perform service actions for the vehicle. The user can respond to a particular element of the diagnostic report at step 626 with an appropriate service action. Once the service action is completed, the diagnostic report is updated with an indication that the service action was performed, and the method proceeds to step 628. At step 628, it is determined if there are any other elements of the diagnostic report that have not yet been addressed. If additional elements of the diagnostic report have not been addressed, the method returns to step 624 to permit a user to address another element of the diagnostic report. If all elements of the diagnostic report have been addressed, the method proceeds to step 630 and the method ends.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vehicle diagnostic system comprising:
a diagnostic server with a memory, the memory having stored thereon instructions to interface with a plurality of diagnostic protocols;
a vehicle communication interface (VCI) in data communication with the diagnostic server, the VCI configured to interface with a diagnostic bus of a vehicle; and
a human-machine interface (HMI) in data communication with diagnostic server, the HMI having an input component and an output component,
wherein,
the diagnostic server generates a diagnostic report in response to receiving diagnostic data compatible with one of the diagnostic protocols from the VCI,
the diagnostic server is configured to relay a command from the HMI to the diagnostic bus via the VCI,
the diagnostic server is configured to relay data from the diagnostic bus via the VCI to the HMI, and
wherein the diagnostic server is in data communication with the HMI via a wide-area network (WAN).

2. The vehicle diagnostic system of claim 1, wherein the VCI comprises a gateway module installed in the vehicle.

3. The vehicle diagnostic system of claim 1, wherein the plurality of diagnostic protocols includes a Controller Area Network (CAN) protocol and a Local Interconnect Network (LIN) protocol.

4. The vehicle diagnostic system of claim 1, wherein the plurality of diagnostic protocols includes a Controller Area Network (CAN) protocol and a Diagnostics Over Internet Protocol (DOIP) protocol.

5. The vehicle diagnostic system of claim 1, wherein the diagnostic server is in data communication with the VCI via the WAN.

6. The vehicle diagnostic system of claim 5, wherein the WAN comprises the Internet.

7. The vehicle diagnostic system of claim 1, wherein the diagnostic bus of the vehicle comprises a Controller Area Network (CAN) bus.

8. The vehicle diagnostic system of claim 1, wherein the diagnostic bus of the vehicle comprises a Diagnostics Over Internet Protocol (DOIP) bus.

9. The vehicle diagnostic system of claim 1, wherein the diagnostic server is in data communication with a specialty server, the specialty server having a specialty memory storing thereon instructions for utilizing a specialty diagnostic protocol distinct from each of the plurality of diagnostic protocols.

10. The vehicle diagnostic system of claim 9, wherein the specialty diagnostic protocol is associated with a component of the vehicle, and wherein the utilization of the specialty diagnostic protocol is authorized by a manufacturer of the component.

11. A method of vehicle diagnostics comprising:
establishing a data connection between a vehicle communication interface (VCI) of a vehicle under diagnostic test and a diagnostic server;
establishing a data connection between a human-machine interface (HMI) and the diagnostic server via a wide-area network (WAN);
transmitting initiation data from the HMI to the diagnostic server to initiate a diagnostic procedure of the vehicle;
transmitting the initiation data from the diagnostic server to the VCI to initiate the diagnostic procedure;
generating a diagnostic report based upon diagnostic data received from the VCI in response to the initiation data; and
transmitting the diagnostic report to the HMI,
wherein
the VCI is in data communication with a diagnostic bus of the vehicle, and
the diagnostic server is configured to interface with a plurality of diagnostic protocols,
at least one of the plurality of diagnostic protocols being utilized by the vehicle.

12. The method of claim 11, wherein the step of generating a vehicle diagnosis further comprises:
transmitting the diagnostic data to a specialty server having a specialty memory storing thereon instructions for utilizing a specialty diagnostic protocol distinct from each of the diagnostic protocols;
generating the diagnostic report based upon the diagnostic data utilizing the specialty diagnostic protocol; and
transmitting the diagnostic report to the diagnostic server from the specialty server.

13. The method of claim 12, wherein the specialty diagnostic protocol is associated with a component of the vehicle, and wherein the utilization of the specialty diagnostic protocol is authorized by a manufacturer of the component.

14. The method of claim 11, wherein the plurality of diagnostic protocols comprises at least a Controller Area Network (CAN) protocol and a Local Interconnect Network (LIN) protocol.

15. The method of claim 11, wherein the VCI comprises a gateway module installed in the vehicle.

16. The method of claim 11, wherein the WAN comprises the Internet.

17. The method of claim 11, wherein the diagnostic protocol utilized by the vehicle comprises a Controller Area Network (CAN) protocol.

18. The method of claim 11, wherein the diagnostic protocol utilized by the vehicle comprises a Diagnostics Over Internet Protocol (DOIP) protocol.
